(19) United States
(12) Patent Application Publication
(10) Pub. No.: US 2011/0282808 A1
(43) Pub. Date: Nov. 17, 2011

(54) UTILITY CONSUMPTION RECOMMENDATION

(75) Inventors: Martha Amram, Palo Alto, CA (US); Efrat Kasznik, Stanford, CA (US)

(73) Assignee: Ennovationz, Inc., Mountain View, CA (US)

(21) Appl. No.: 13/112,986

(22) Filed: May 20, 2011

Related U.S. Application Data
(63) Continuation-in-part of application No. 13/109,960, filed on May 17, 2011.
(60) Provisional application No. 61/345,261, filed on May 17, 2010.
(60) Provisional application No. 61/346,697, filed on May 20, 2010.

(51) Int. Cl. G06Q 50/00

(52) U.S. Cl. 705/412

(57) ABSTRACT

A computer-implemented method is disclosed for generating and presenting personalized recommendations of improving utility consumption efficiency of a dwelling based on an itemized utility consumption profile generated from historical utility consumption data. The computer-implemented method comprises obtaining data indicating historical utility consumption of a dwelling over a time period to produce an itemized utility consumption profile. A list of recommendations for improving utility consumption efficiency is generated based on the itemized utility consumption profile, and a reduction in utility consumption for each recommendation is estimated based on the historical consumption profile. The recommendations may be ranked, modified, or bundled to produce personalized recommendations, which may increase the likelihood of implementation.

### CROSS-REFERENCE TO RELATED APPLICATION

This application claims the benefit under 35 U.S.C. 119(e) of U.S. Provisional Application Ser. No. 61/346,697, titled “Utility Consumption Saving Methods” filed on May 20, 2010. This application is also a continuation-in-part of U.S. application Ser. No. 13/109,960, titled “Historical Utility Consumption Disaggregation” filed on May 17, 2011, which claims priority from U.S. Provisional Application Ser. No. 61/345,261, titled “Historical Utility Consumption Disaggregation Methods” filed on May 17^{th}, 2010. Entire teachings of the above applications are incorporated herein by reference.

### BACKGROUND

1. Field of the Disclosure

The present disclosure relates generally to generating utility savings recommendations by analyzing historical utility consumption data.

2. Description of the Related Art

With the growing awareness of global warming, climate change, and rising energy costs, consumers and industry increasingly demand greater efficiency in utility consumption. Recently, efforts have been made to activate the residential sector in improving utility consumption efficiency, as the residential sector accounts for 37% of annual electric sales and 21% of natural gas sales. Thus, improving residential utility consumption efficiency may affect energy consumption in a geographic region and lead to monetary savings for the consumers.

However, the residential sector has long been considered the hardest to reach for catalyzing consumption efficiency savings. Some of the barriers to consumer adoption as identified in “Market Failures and Barriers for Clean Energy Policies” by Marilyn Brown, appearing in Energy Policy (29) published in 2001, include lack of information, lack of connection to specific opportunities in the dwelling, and lack of clarity about benefits.

To overcome the barriers, it would be desirable to provide novel devices, systems, and methods to disaggregate utility consumption of a dwelling with sufficient resolution in order to obtain an understanding of the utility consumption of the dwelling. Using these disaggregated data, improvements in efficiency can be suggested, evaluated, implemented, and monitored. Specifically, it would be desirable to generate a dwelling-specific utility consumption profile based on historical utility consumption information, and generate a savings profile indicating targeted recommendations to improve utility consumption efficiency. At least some of these objectives will be met by the inventions described below.

### SUMMARY OF THE INVENTION

The present disclosure provides for computer-implemented devices, systems, and methods of making personalized utility savings recommendations based on a dwelling-specific historical utility consumption profile.

In one aspect, a historical utility consumption data for a dwelling over a period of time is obtained. The historical utility consumption data is itemized by computing a seasonal portion and a non-seasonal portion of total utility consumption. The non-seasonal portion is determined based on an average utility consumption of one or more predetermined intervals within the time period. The seasonal portion is a difference between the total consumption and the non-seasonal consumption.

In one aspect, after the historical utility consumption data has been itemized, a list of recommendations for improving utility consumption efficiency is generated, and a reduction in utility consumption for each recommendation is estimated based on the historical consumption profile. Thereafter, a savings profile indicating the recommendations and their corresponding reduction estimates are generated and may be presented to the user. Additionally, the corresponding reduction estimates may be presented to the user as a percentage of historical utility consumption.

In one aspect, the recommendations may be ranked in a savings profile according to one or more characteristics of the recommendations or one or more preferences of occupants of the dwelling. The recommendations may be ranked in the savings profile according to their corresponding reduction estimates, estimated monetary savings, estimated carbon savings, cost of implementing the recommendations, or ease of implementing the recommendations.

In another aspect, the recommendations may be ranked in the savings profile based on one or more preferences of the occupants, such as comfort or carbon emission reduction. The recommendations may also be ranked based on popularity, instances of implementation by similar dwellings or dwellings in the same geographic region, or highest return in terms of savings relative to investments in implementing the recommendations. Additionally, the recommendations may be ranked in the savings profile such that when a first recommendation builds upon a second recommendation, for example when effectiveness of first recommendation is affected by a second recommendation, then the first recommendation is ranked lower than the second recommendation. Additionally, the recommendations may be bundled as a collection of recommendations according to one or more characteristics.

In yet another aspect, the recommendations may be ranked in the savings profile based on likelihood of action by the occupants of the dwelling, wherein the likelihood of action is based on psychographic data derived from the occupants and/or the geographic region associated with the dwelling.

In another aspect, the present computer-implemented devices, systems, and methods comprise obtaining historical utility consumption of geographical region of the dwelling and presenting a comparison of the historical utility consumption of the dwelling and the historical utility consumption of the geographical region.

Other aspects and variations are presented in the detailed description as follows.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a flow diagram illustrating generation of a personalized utility savings recommendation profile.

FIG. 2 illustrates one exemplary environment where present embodiments may operate in.

FIG. 3A illustrates an exemplary utility consumption profile presented to the user showing an energy efficiency spectrum and a comparison of dwelling utility consumption profile with two utility consumption benchmarks.

FIG. 3B illustrates an exemplary dwelling utility consumption profile as indicated on a utility billing tier.

### DETAILED DESCRIPTION

Although the detailed description contains many specifics, these should not be construed as limiting the scope of the disclosure but merely as illustrating different examples and aspects of the disclosure. It should be appreciated that the scope of the disclosure includes other embodiments not discussed in detail herein. Various other modifications, changes, and variations, which will be apparent to those skilled in the art, may be made in the arrangement, operation, and details of the methods and processes of the present disclosure disclosed herein without departing from the spirit and scope of the disclosure as described.

In accordance with one aspect of the disclosed computer-implemented devices, systems, and methods, a personalized utility savings profile for a dwelling is generated by first generating a utility consumption profile of the dwelling. Based on the utility consumption profile, a list of dwelling-specific recommendations is generated. Next, for each recommendation, an estimated reduction in utility consumption is calculated. Finally, the utility savings profile is presented to the user, wherein the profile indicates the recommendations along with their estimated reduction in consumption.

As referred herein, the term “dwelling” is meant to include any building, including a single family home, multi-family home, condominium, townhouse, industrial building, commercial building, public building, academic facility, governmental facility, etc. Additionally, as referred to herein, the “historical utility consumption data” is meant to include any utility consumption data including, but not limited to electricity data, natural gas data, and water data. It is further contemplated that the historical utility consumption data may include data relating to other recurring service consumed that is substantially associated with the dwelling, for example, Internet service, cellular voice or data service, etc. The historical utility consumption data may be collected by presenting a user-interface, wherein the user may input the data.

In order to generate savings profile comprising dwelling-specific recommendations and saving estimates, it may be advantageous to generate a historical utility consumption profile comprising substantially accurate consumption information that indicates utility consumptions attributable to one or more features of the dwelling. In one embodiment, the utility consumption profile is obtained by disaggregating historical utility consumption data of a dwelling for a time period. The historical utility consumption data may be collected by presenting a user-interface, wherein the user may input the data, or alternatively, the data may be automatically obtained.

As described in more detail in the co-pending U.S. application Ser. No. 13/109,960, filed on May 17, 2011 incorporated herein in its entirety, the historical utility consumption data may be disaggregated into historical non-seasonal utility consumption and seasonal consumption, wherein the non-seasonal and seasonal consumption accounts for substantially the entirety of the total historical consumption data. Generally, non-seasonal utility consumption is utility consumption that is substantially unaffected by variation in environmental factors such as temperature, precipitation, humidity, etc., whereas the seasonal utility consumption is substantially affected by such environmental factors.

The non-seasonal utility consumption is calculated based on an average of a predetermined interval. The predetermined interval is selected to be a period where utility consumption is substantially unaffected by environmental variations. The average of the predetermined interval is then applied to the time period of the historical utility data to obtain the non-seasonal portion of utility consumption. The non-seasonal portion is then subtracted from the total utility consumption to obtain the seasonal portion.

Furthermore, both the non-seasonal and seasonal portions may be further disaggregated by using end-use methods to attribute utility consumption of various dwelling features such that the utility consumption over a time period is itemized to the dwelling features. As referred herein, the term “dwelling feature” is meant to include any dwelling structural features such as architectural type, construction material, year of construction, etc. Dwelling feature is further meant to include any dwelling interior features such as type of appliances, utility consuming devices, apparatus, etc. Furthermore, the term dwelling feature is contemplated to include any other utility consumption sources associated with the dwelling.

In one embodiment, the itemized utility consumption profile is an itemized natural gas consumption profile, and the seasonal consumption is natural gas consumption attributable to seasonal heating. In another embodiment, the itemized utility consumption profile is an itemized electricity consumption profile, and the seasonal consumption is electricity consumption attributable to seasonal cooling. In yet another embodiment, the itemized utility consumption profile is an itemized water consumption profile, and the seasonal consumption is water consumption attributable to outdoor water consumption.

The itemized utility consumption profile is advantageous since by isolating the amount of consumption, it enables a user to identify savings opportunities for the dwelling. Furthermore, since the utility consumption profile is based on historical consumption data for the dwelling, the profile offers a realistic and individualized view of the dwelling utility consumption. Alternatively, it is contemplated that the utility consumption profile may be calculated and/or obtained through other methods.

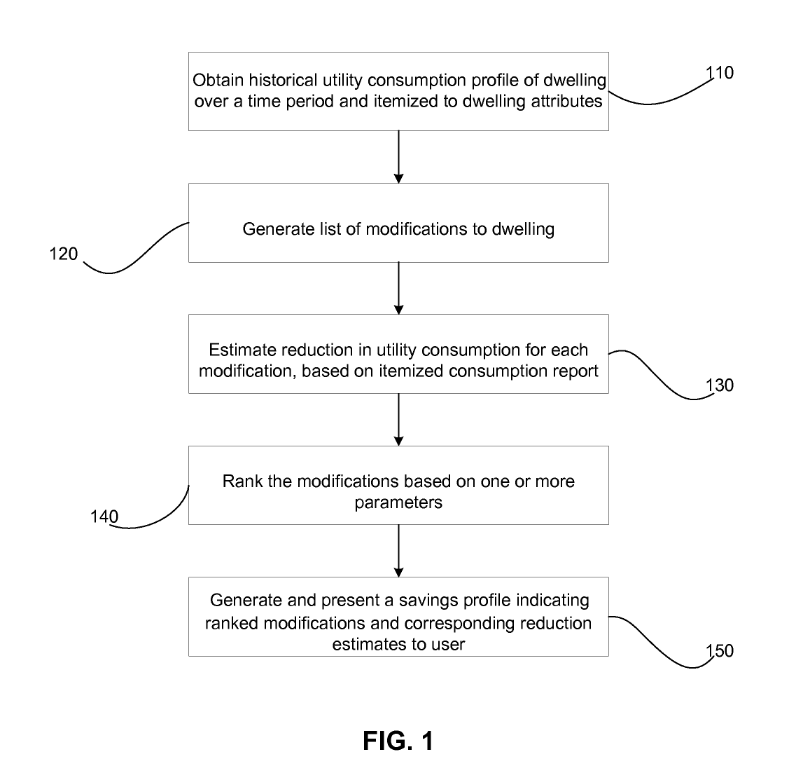

Referring now to FIG. 1, which is a flow diagram illustrating one embodiment of the disclosed utility savings method. At step 110, a utility consumption profile is generated. It is envisioned that the utility consumption profile may comprise various levels of data granularity. In one embodiment, the utility consumption profile may be an itemized dwelling-specific utility consumption profile as determined by the method described above.

At step 120, once the itemized utility consumption profile has been generated, the utility consumption is analyzed to determine whether consumption efficiency of the various consumption sources may be improved. When it is determined that the consumption efficiency may be improved, one or more dwelling-specific recommendations may be generated. As referred herein, the term “recommendations” is meant to include modifying behaviors of occupants of the dwelling, replacing, removing and/or adding appliances, electronic devices or apparatus in the dwelling, or modifying one or more characteristics of the dwelling, etc.

The generated recommendations are targeted at improving consumption efficiency of one or more utility consumption sources. For example, when it is determined that the efficiency of electricity consumption for summer cooling may be improved, the present embodiments may generate recommendations such as improving insulation of the dwelling and/or replacing an air conditioner.

Additionally and optionally, the recommendations generated may be modified such that they may be successfully implemented given the characteristics of the dwelling. Specifically, the recommendations may be modified based on dwelling characteristics such as geographic location, architectural type, construction material, etc., to ensure that the implementation of the recommendations is feasible and/or effective. For example, it is generally not feasible or effective to add solar panels to a dwelling located in a geographic region that receives minimum direct sunlight; therefore, such recommendations would not be generated for that dwelling. Furthermore, the recommendations may be personalized according to one or more psychographic profiles described in detail below.

At step 130, after the recommendations have been generated, an estimation of reduction in utility consumption based on the recommended modification is produced. The estimation may be represented as reduced utility consumption (measured in consumption units such as therms, kWh, CCF, etc.), reduced utility spending (measured in monetary units such as dollars), and/or reduced byproduct emission such as carbon dioxide emission (measured in kg, lb, etc.). In one embodiment, the various estimations are presented as a percentage of the historical utility consumption and various reduction estimations are presented as a percentile improvement over historical consumption.

At step 140, the various recommendations may be ranked according to one or more parameters, such that a prioritized list of potential savings opportunities may be generated and presented to the user. In one embodiment, the recommendations are ranked according to their corresponding consumption reduction estimates. In another embodiment, the recommendations are ranked according to their corresponding monetary savings estimates. In another embodiment, the recommendations are ranked according to their carbon reduction estimates or carbon savings. In yet another embodiment, the recommendations may be ranked according to their characteristics or preference of occupants of the dwelling; for example, the preferences of an occupant may be ease of implementation, reduction of negative environmental impact, energy independence, and/or improvement of comfort. The various recommendations may be ranked according to such preferences.

Additionally and optionally, the various recommendations may be ranked based on their relationships to other recommendations to maximize their effectiveness. The relationships of the recommendations may be determined base on factors such as the characteristics of the dwelling shell, which includes type of windows, type of insulation, presence of air leaks, etc., characteristics of mechanical systems, such as heating/cooling apparatus, and water heater as well as comfort/thermostat behavior. For example, when the various recommendations comprise modifying insulation of the dwelling and replacing the air conditioner, in accordance with the principles of the present embodiments, the insulation recommendation is configured to be ranked higher than the air conditioner recommendation, such that the user is prompted to modify insulation before replacing the air conditioner. In such embodiments, replacing the air conditioner may be more effective since the dwelling already has improved insulation.

Furthermore, in the embodiment where the recommendations are ranked based on their relationships, the estimation of savings based on the recommendations may be recalculated once a recommendation is contemplated. Once a recommendation such as insulation modification is contemplated, the savings estimation of additional recommendations such as replacing the air conditioner may be modified to incorporate the energy savings effect of the contemplated recommendation on the additional recommendation.

Furthermore, the various recommendations may be grouped into one or more recommendation bundles according to the characteristics of the recommendations and/or preferences of the occupants. Additionally, utility reduction estimates may be generated for the one or more bundles.

In one embodiment, the various recommendations may be grouped according to their relationships such that the recommendations configured to modify a particular consumption source may be grouped into one bundle. In another embodiment, the various recommendations may be grouped according to an estimated consumption, monetary, and/or carbon savings. For example, recommendations that produce the greatest carbon savings may be grouped together as one bundle.

It is further contemplated that the various recommendations may be grouped according to an ease of implementation. For example, the various easily implementable recommendations such as behavioral modifications or minor fixes may be grouped as one bundle. Such bundle may comprise recommendations that can be done by the dwelling occupants including replacing showerheads, modifying dwelling temperature settings, etc.

The various recommendations that are more difficult to implement may be grouped together comprising small-scale dwelling modifications such as replacing water faucets, air sealing of the dwelling, switching to energy efficient appliances, etc. Furthermore, various recommendations that are most difficult to implement may be grouped together comprising major dwelling modifications such as replacing the air conditioner, adding solar panels, etc.

At step 150, a savings profile may be generated and presented to the user comprising various recommendations along with the estimations of reduction in utility consumption measured as monetary savings, byproduct reduction such as carbon reduction/savings, and/or consumption savings. In one embodiment where the various recommendations are ranked, the savings profile may comprise various recommendations in one or more ranked formats. Additionally, the savings profile may comprise one or more recommendations bundles with their corresponding estimations of reduction as described above.

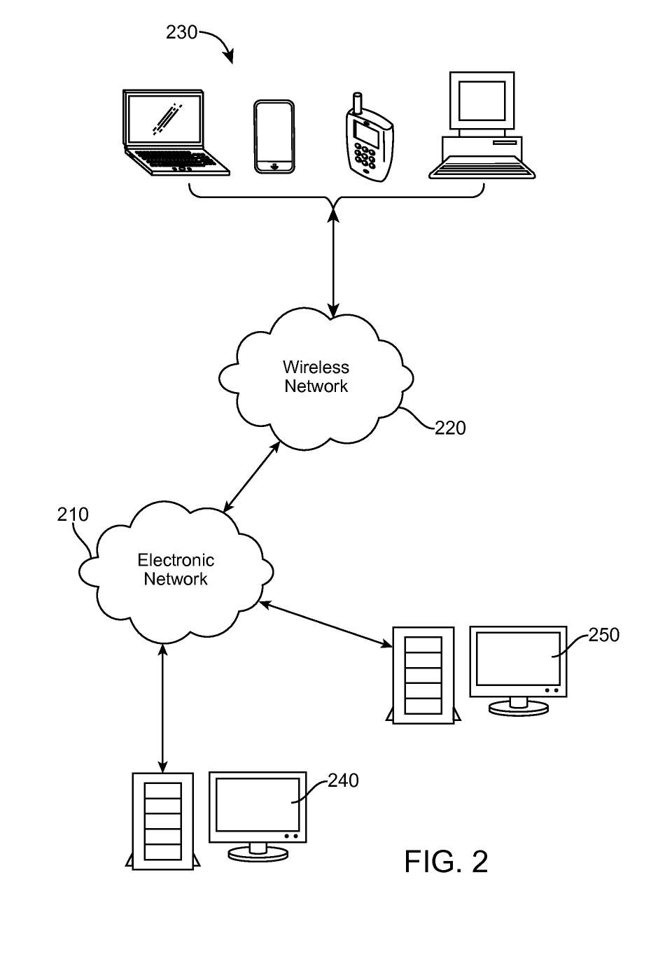

Referring now to FIG. 2, which illustrates components of one embodiment of an environment in which the present disclosure may be practiced. It should be noted, that not all the components described herein may be required to practice present embodiments, and variation may be made without departing from the scope of the present disclosure.

FIG. 2 shows an exemplary operating environment comprising an electronic network 210, a wireless network 220, at least one end-use device 230, a profile generator 240, and a savings generator 250. The electronic network 210 may be a local area network (LAN), wide-area network (WAN), the Internet, or the like. The wireless network 220 may be various networks that implement one or more access technologies such as Global System for Mobile Communications (GSM), General Packet Radio Services (GPRS), Enhanced Data GSM Environment (EDGE), Code Division Multiple Access (CDMA), Wideband Code Division Multiple Access (WCDMA), Bluetooth, ZigBee, High Speed Packet Access (HSPA), Long Term Evolution (LTE), Worldwide Interoperability for Microwave Access (WiMAX), Wi-Fi, or the like.

The wireless network 220 and the electronic network 210 are configured to connect the end-use device 230 and the profile generator 240. It is contemplated that the end-use device 230 may be connected to the profile generator 240 by utilizing the electronic network 210 without the wireless network 220. It is further contemplated that the end-use device 230 may be connected directly to the profile generator 240 without utilizing a separate network, for example, through a USB port, Bluetooth, infrared (IR), firewire port, thunderbolt port, ad-hoc wireless connection, or the like.

The end-use device 230 may be desktop computers, laptop computers, tablet computers, personal digital assistants (PDA), smart phones, mobile phones, or the like. Generally, the end-use device 230 may comprise a processing unit, memory unit, one or more network interfaces, video interface, audio interface, and one or more input devices such as a keyboard, a keypad, or a touch screen. The input devices may also include auditory input mechanisms such as a microphone, graphical or video input mechanisms, such as a camera and/or a scanner. The end-use device 230 may further comprise a power source that provides power to the end-use devices 230 including an AC adapter, rechargeable battery such as Lithium ion battery or non-rechargeable battery.

The memory unit of the end-use device 230 may comprise random access memory (RAM), read only memory (ROM), electronic erasable programmable read-only memory (EEPROM), and basic input/output system (BIOS). The memory unit may further comprise other storage units such as non-volatile storage including magnetic disk drives, flash memory, or the like.

The end-use device 230 may further comprise a display such as a plasma display, a projector, liquid crystal display (LCD), light emitting diode (LED), organic light emitting diode (OLED), cathode ray tube (CRT) display, or the like. Optionally, the end-use devices 230 may comprise one or more global position system (GPS) transceivers that can determine the location of the end-use device 230 based on the latitude and longitude values. Additionally and optionally, the position data may be obtained through cell tower triangulation, Wi-Fi positioning, or any other methods or technologies for obtaining the position of the end-use device 230.

The network interface of the end-use device 230 may directly or indirectly communicate with the wireless network 220 such as through a base station, a router, switch, or other computing devices. In one embodiment, the network interface of the end-use device 230 may be configured to utilize various communication protocols such as GSM, GPRS, EDGE, CDMA, WCDMA, Bluetooth, ZigBee, HSPA, LTE, and WiMAX. The network interface of the end-use device 230 may be further configured to utilize user datagram protocol (UDP), transport control protocol (TCP), Wi-Fi, satellite links and various other communication protocols, technologies, or methods. Additionally, the end-use device 230 may be connected to the electronic network 210 without communicating through the wireless network 220. The network interface of the end-use device 230 may be configured to utilize analog telephone lines (dial-up connection), digital lines (T1, T2, T3, T4, or the like), Digital Subscriber lines (DSL), or the like.

In one embodiment, the end-use device 230 is a web-enabled device comprising a browser application such as the Microsoft Internet Explorer, Google Chrome, Mozilla Firefox, Apple Safari, Opera, or any other browser or mobile browser application that is capable of receiving and sending data, and/or messages through a network. The browser application may be configured to receive the display data such as graphics, text, multimedia using various web-based languages such as hyperText Markup Language (HTML), Handheld Device Markup Language (HDML), eXtendable markup language (XML), or the like.

The end-use device 230 may comprise other applications including one or more messengers configured to send, receive, and/or manage messages such as email, short message service (SMS), instant message (IM), multimedia message services (MMS), or the like. The end-use device may further comprise mobile application, such as iOS apps, Android apps, or the like.

Furthermore, the end-use device 230 may include a web-enabled application that allows a user to access a system managed by another computing device, such as the profile generator 240 and/or the savings generator 250. In one embodiment, the application operating on the end-use device 230 may be configured to enable a user to create, manage, and/or log into a user account residing on the profile generator 240 and/or the savings generator 250.

In general, the end-use device 230 may utilize various client applications such as browser applications, dedicated applications, or web widgets to send, receive, and access content such as utility consumption data and utility savings data residing on the profile generator 240 and/or the savings generator 250 via the wireless network 220, and/or the electronic network 210.

In general, the profile generator 240 and the savings generator 250 may be one or more network computing devices that are configured to provide various resources and services over a network. For example, a network computing device may be configured to provide FTP services, APIs, web services, database services, processing services, or the like. It is noted that the profile generator 240 and the savings generator 250 may be implemented as one network computing device, or they may be implemented as multiple network computing device. Furthermore, it is noted that the various components or functions of the profile generator 240 and the savings generator 250 may be implemented as one network computing device or may be distributed over multiple network computing devices.

In general, the network computing device comprises a processing unit (CPU), memory unit, video or display interface, network interface, input/output interface and bus that connect the various units and interfaces. The network interface enables the network computing device to connect to the Internet or other network. The network interface is adapted to utilize various protocols and methods including but not limited to UDP, and TCP/IP protocols. The network computing device 300 may comprise other components not described herein, as described herein is only one embodiment of a network computing device. As stated, the network computing device may represent the profile generator 240 and/or the savings generator 250.

The memory unit of the network computing device may comprise random access memory (RAM), read only memory (ROM), electronic erasable programmable read-only memory (EEPROM), and basic input/output system (BIOS). The memory unit may further comprise other storage units such as non-volatile storage including magnetic disk drives, flash memory, or the like.

The network computing device further comprises an operating system and various applications such as database programs including a data manager that is configured to store and manage data such as webpage, personal information, utility consumption data, benchmarks, etc. The network computing device may comprise account management programs such as an account manager that is configured to manage and control user access of the data stored within the memory unit through various authorization and authentication methods The network computing device further comprises other applications such as hyper text transport protocol (HTTP) programs, user-interface programs, IPSec. programs, VPN programs, web service programs, or the like.

The network computing device may be configured to provide various web services that transmit or deliver content over a network to the end-use device 230. Exemplary web services include web server, database server, massager server, content server, etc. Content may be delivered to the end-use device 230 as HTML, HDML, XML, or the like.

In one embodiment, where the network computing device is configured as the profile generator 240, the network computing device comprises a profile service that is configured to receive historical utility consumption data of a dwelling over a time period. In one embodiment, the web service of the profile generator 240 may be configured to provide a user-interface such as a webpage that is presented to a user through the end-use device 230. Alternatively, the user-interface may be presented to the user through a dedicated application, a mobile app, a web widget, or the like.

The user-interface is configured to prompt the user to upload the historical utility consumption data to the profile service. The upload may comprise uploading a historical utility consumption document file of various formats such as PDF, Microsoft Word, Microsoft Excel, Microsoft PowerPoint or the like. The upload may further comprise scanning and uploading an image of the historical utility consumption document using a scanner, and capture and upload an image of the historical utility consumption document using a camera. Alternatively, the user may manually input the historical utility consumption data through the user-interface.

In another embodiment, the user-interface may prompt the user to enter information such as the address of the dwelling and the profile service is configured to automatically obtain the historical utility consumption data from the data manager or one or more external databases. Furthermore, the profile service may receive location data from the GPS transceiver of the end-use device 230, and the profile service may obtain the historical utility consumption data based on the location data. Furthermore, the user-interface my prompt the user to enter other user-related data such as age, education level, number of residents in the dwelling, and environmental awareness. Once the profile service obtains the historical utility consumption data and/or other user-related data, the data manager may store the data in the memory unit.

The profile service may further provide one or more user-interfaces that allows the collection of data indicating one or more parameters of the dwelling, including dwelling features such as number of appliances in the dwelling, their types, and behavioral-dependent features such as appliance usage frequencies.

The profile service may further comprise a data extractor that is configured to extract data from the obtained historical utility consumption data. In one embodiment, the data extractor is configured to extract data from an uploaded historical utility consumption document file such as a PDF, Microsoft Word, Microsoft Excel, Microsoft PowerPoint, or the like. In another embodiment, the data extractor is configured to extract data from an uploaded image of a historical utility consumption document. The data extractor may be further configured to extract data from the historical utility consumption data obtained through one or more databases. Additionally and optionally, the data extractor may be configured to extract data from the manually inputted historical utility consumption data.

Based on the extracted data, the profile service may compute a non-seasonal portion of the historical utility consumption data by first computing an average utility consumption based on one or more predetermined intervals within the time periods, and computing the non-seasonal portion by applying the average to the time period, subtracting the non-seasonal portion from the historical utility consumption data to obtain a seasonal portion of the historical utility consumption data as described above and in the above referenced co-pending U.S. application Ser. No. 13/109,960.

The profile service is further configured to generate a utility consumption profile for the dwelling based on the disaggregated historical utility consumption data. The generated utility consumption profile may then be transmitted to the end-use device 230, whereby it is presented to the user through a webpage, a dedicated application, a mobile app, a web widget, or the like. The utility consumption profile may comprise a seasonal utility consumption portion and a non-seasonal utility consumption portion. Specifically, the seasonal utility consumption is presented along with the origin of the seasonality such as winter heating, summer cooling, etc.

Furthermore, the utility consumption profile generated by the profile service may comprise the percentage of total historical utility consumption attributed to various consumption sources, average utility spending, and percentage of total spending attributable to various consumption sources, byproducts emitted by consumption such as carbon, and/or percentage of total carbon emissions attributable to the various consumption sources.

Additionally and optionally, the profile service may compare the utility consumption profile with one or more utility consumption benchmarks. The utility consumption benchmarks are one or more utility consumption profiles that share one or more attributes with the generated utility consumption profile of the dwelling. The benchmarks may be a utility consumption average of similar dwellings in the region where the dwelling is located, a predetermined low (efficient) utility consumption benchmark, and/or a high (wasteful) utility consumption benchmark.

It is further contemplated that the utility consumption benchmark may be a utility consumption of a nearby dwelling, average utility consumption of an area such as a street, a neighborhood, a city, or a country. The utility consumption benchmark may also be an average utility consumption of a group sharing similar education level, income level, similar profession or the like. Furthermore, the utility consumption benchmark may be utility consumptions of one or more individuals that are connected to the user through direct relationships (friends, co-workers, family members), and/or utility consumptions of one or more social network connections of the user, such as Facebook, MySpace, and/or LinkedIn connections.

The profile service may further comprise a selection service that is configured to select the relevant utility consumption benchmarks based on the data received from the end-use device. For example, the selection processor may select a benchmark based on the location data received through the GPS transceiver and/or user inputted data such as address. The selection service may also select a benchmark based on other data such as the income level, education level, and environmental awareness of the inhabitants of the dwelling. The selection service may also select a benchmark based on the user's social network connections. The benchmark data may be stored within the data manager or they may reside on one or more separate computing devices, whereby the selection service may communicate with one or more separate computing devices to obtain the desired benchmark. It is also contemplated that the benchmark may be dynamically generated based on the various data collected from the user. For example, the selection service may compute an individualized benchmark based a combination of data such as the location of the dwelling and/or education of the occupants.

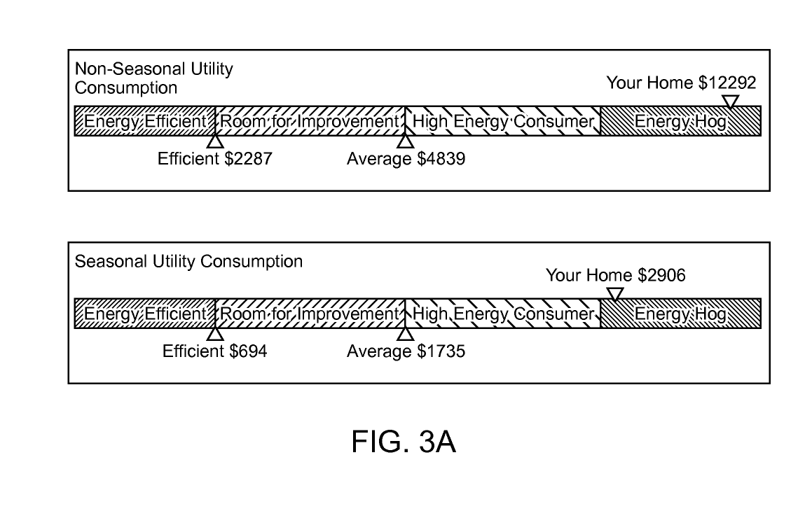

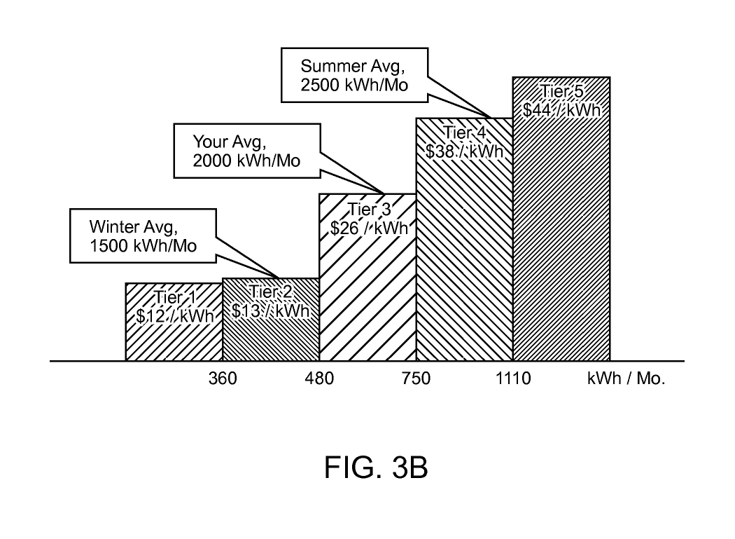

The profile service is configured to transmit the utility consumption profile and optionally the benchmarks to the end-use device, wherein the utility consumption profile may be graphically presented to the user through a user-interface. In one embodiment, utility consumption of the dwelling and the one or more utility consumption benchmarks may be indicated on an energy usage spectrum as depicted in FIG. 3A. As seen in FIG. 3A, the utility consumption of the dwelling is indicated along the spectrum representing the degree of energy efficiency. The one or more utility consumption benchmarks are also indicated along the spectrum, which enables the user to determine deviations, if any, between the dwelling utility consumption and the utility consumption benchmarks.

Furthermore, as depicted in FIG. 3B, a billing tier used by a utility provider associated with the dwelling may be presented to the user indicating the utility billing level of the dwelling. Specifically, an average or total of the historical utility consumption data, a seasonal utility consumption data, and/or a non-seasonal utility consumption data corresponding to a billing cycle used by a utility provider is indicated on the billing tier applicable to the computed average consumption. As seen in FIG. 3B, the utility consumption of the dwelling is indicated along the spectrum representing the degree of energy efficiency.

In one embodiment, where the network computing device is configured as the savings generator 240, the network computing device comprises a savings service that is configured to generate a list of recommendations to improve utility consumption efficiency of the dwelling, compute an estimate of reduction in utility consumption for the recommendation, and generate a savings profile indicating the recommendations and their corresponding reduction estimates. In one embodiment, the savings service is configured to obtain a historical utility consumption profile for a dwelling from the profile generator 240. The savings service may further provide one or more user-interfaces that allows the collection of data indicating one or more parameters of the dwelling, including dwelling features such as number of appliances in the dwelling, their types, and behavioral-dependent features such as appliances usage frequencies. Furthermore, the user-interface my prompt the user to enter other data such as age, education level, number of residents in the dwelling, and environmental awareness.

The savings service further comprises a recommendation service that is configured to extract utility consumption data from the historical utility consumption profile to determine and generate recommendations based on recommendation data to improve utility consumption efficiency. The recommendation data may be stored within the data manager and/or stored on another computing device, whereupon the recommendation service is configured to communicate with the data manager and/or other computing device to obtain the recommendation data. The recommendation service may select recommendations based on dwelling characteristics such as geographic location, architectural type, construction materials, etc. to determine the feasibility or effectiveness of implementing one or more of the recommendations.

The recommendation service may further select recommendations based on demographic data including age, education level, number of residents in the dwelling and/or psychographic profile including data relating to environmental awareness, voting pattern, religious affiliation, ethnicity, attitude towards risk, etc. of the occupants of the dwelling. Additionally and optionally, the psychographic profile may be supplemented by demographic data such as income level, average age, number of occupants, profession, marital status, etc.

The savings service may further comprise an estimation service configured to generate one or more estimations of reduction utility consumption based on the recommendations, the estimation may be represented as reduced utility consumption, reduced utility spending, and/or reduced byproduct emission.

The savings service may comprise a ranking service configured to arrange the recommendations according one or more parameters. In one embodiment, the ranking service may rank the various recommendations based on their relationship to other recommendations to maximize their effectiveness. Additionally and optionally, the ranking service may present a user-interface comprising a series of configurable parameters in order to rank savings recommendations. In one embodiment, the user may be presented with a user-interface that allows the user to select the parameters such as environmental impact, energy independence, ease of implementation, improvement of comfort, monetary savings, etc. Based on the user selection, the ranking service is configured to compute a prioritized list of potential savings opportunities based on the recommendations. The ranking service may further provide a user-interface with one or more interactive elements such as one or more slider bars, wherein one slider may allow the user to choose a range for modification cost, another slider may allow the user to choose a range of desired carbon reduction, and yet another slider may allow the user to choose a range of desired utility consumption reduction. By adjusting the sliders, the user may narrow down the set of available recommendations to those that are desirable to the user. The ranking service may then dynamically adjust a set of recommendations such that they are in accordance with the user's preference and present the total savings in utility reduction according to the selected recommendations to the user. In such embodiments, the user is empowered to determine alternative recommendations than what was previously presented and the savings service is configured to calculate and present the estimated savings based on the user-determined recommendations to the user.

It is further contemplated that the savings service may group the various recommendations into one or more recommendation bundles according to the characteristics of the recommendations, ease of implementation, and/or preferences of the occupants. Additionally, the savings service may comprise a psychographic service that is configured to generate a psychographic profile for a geographic region, a dwelling profile, a community profile, etc. The psychographic service is configured to communicate with one or more databases where the psychographic data resides, and compute various profiles based on the psychographic data and/or additional data as such as historical utility consumption profile, demographic data, etc. The psychographic profile generated by the psychographic service may be used by the recommendation service to select recommendations, and it may be used by the ranking service to rank the recommendations.

The savings service is configured to generate savings profile comprising various recommendations, estimations of reduction in utility consumption measured as monetary savings, byproduct reduction such as carbon reduction/savings, and/or consumption savings. The savings service may be further configured to generate a savings profile where the various recommendations are ranked and/or bundled with their corresponding estimations of reduction in utility consumption. The savings service is further configured to transmit the generated savings profile to the user.

Further variations, modifications, additions to the embodiments of the disclosed computer implemented devices, systems, and methods are described below. It is noted that the various embodiments may be practiced according to the operating environment and components as illustrated in FIG. 2 and described above, or variations thereof.

The present computer-implemented devices, systems, and methods contemplate calculating and presenting an estimated future consumption data incorporating the various potential savings from implementing the recommendations. The estimated future consumption data is configured to reconcile the dwelling's historical utility consumption with the potential savings. For example, an estimated future electricity bill may be presented to the user showing the estimated dwelling consumption after a new air-conditioner has been installed. The estimated future consumption data may comprise the total utility consumption, or a portion of the total utility consumption such as seasonal or non-seasonal utility consumption. Additionally, the estimated future consumption data may be presented to the user along with the historical consumption profile such that the user may determine any deviation in historical utility consumption and estimated future utility consumption.

The present computer-implemented devices, systems, and methods also contemplate computing potential savings related to implementing a recommendation (i.e., installing a new solar panel, obtaining a new appliance, etc.). The potential savings may include government and/or non-government sponsored rebates, coupons, tax incentives, current and/or future discounts for implementing the recommendations, or other potential savings. In one embodiment, a user-interface is presented and prompts the user to enter location information of a dwelling, such as the street address, zip code, county, city, state, and/or country where the dwelling resides. The user-interface may also prompt the user to select one or more desired recommendations, such as installing a solar panel. Thereupon receiving the location information and the recommendation selection, a potential savings related to implementing a recommendation is computed and presented to the user. It is further contemplated that an estimated total cost for implementing the recommendation in light of the potential savings may be computed and presented to the user. The total cost may be further modified based on projected long term monetary savings due to increased utility consumption efficiency.

Furthermore, the present embodiments contemplate constructing and using one or more psychographic profiles of one or more occupants of the dwelling to generate one or more recommendation bundles that are specifically created to target a lifestyle, behavior, or motivation of the occupants to increase a likelihood of action. The psychographic profile may comprise occupant-related data beyond that of typical demographic data. In one embodiment, the psychographic profile comprises data relating to environmental awareness, voting pattern, religious affiliation, ethnicity, attitude towards risk, etc. of the occupants of the dwelling. Additionally and optionally, the psychographic profile may be supplemented by demographic information such as income level, average age, number of occupants, profession, marital status, etc.

Additionally, a psychographic profile may be generated for a geographic region where the dwelling resides. The geographic region may be a street, a district, a neighborhood, a city, or a zip code area associated with the dwelling. For example, the psychographic profile of Palo Alto, Calif. may be described as “high income, advanced degrees, and sophisticated tastes.” The psychographic information may be obtained from marketing and advertising research data suppliers such as the Nielsen Company, located in New York, N.Y.

The psychographically driven methodology of the present devices, systems, and methods is advantageous since the targeted approach may generally increase the likelihood of adopting and implementing the recommendations. For example, when the psychographic profile indicates that the occupant of the dwelling is environmentally aware and is motivated to reduce carbon output of the dwelling, then the targeted bundle presented to the user may comprise recommendations that represent maximum carbon reduction opportunities. In another example, when the psychographic profile indicates that the occupants of the dwelling are motivated by monetary savings, then the targeted bundle presented to the user may comprise recommendations that present maximum monetary savings opportunities. In yet another example, when the psychographic profile indicates that the occupants of the dwelling are motivated by achieving energy independence, then the targeted bundle present to the user may comprise recommendations such as adding solar panels, etc.

Furthermore, the psychographic data may be utilized to generate a dwelling profile comprising one or more metrics such as attitudes of the occupants of the dwelling regarding energy conservation, awareness of savings opportunities, and utility consumption behavior. The dwelling profile may be utilized to identify occupants that are receptive to utility savings services such as energy audit, dwelling modifications, and/or behavioral modifications as described above.

The dwelling profile may also be used to increase awareness and/or attitudes by providing the occupants with education, counseling, etc. such that the occupants may be better informed of savings opportunities and environmental impact to modify attitude and/or awareness and thus increase the likelihood of implementing the recommendations.

Additionally, the present computer-implemented devices, systems, and methods may be configured to create a community. In one embodiment, the community may be defined by a geographic region where the dwelling resides such as street, a district, a neighborhood, a city, or a zip code area associated with the dwelling. In another embodiment, the community may be a user-created group that may not be constrained within a geographic area. For example, a group of friends that reside in various geographic locations may form a community. Furthermore, it is contemplated that the community may reside in one or more social networks such as Facebook, MySpace, LinkedIn, etc. A community profile comprising the total and/or average utility consumption of a community may be generated. The community profile may further comprise the total savings potential for the community, as well as the community savings potential for a particular recommendation such as the community savings potential for implementing solar power. Additionally and optionally, the community profile may comprise number of instances where a recommendation has been implemented in the geographic region.

The community profile may be used to activate occupants of the dwelling to implement various recommendations by encouraging adaptation of a community utility consumption norm or standard and to benefit the community. The community profile my further comprise a community goal to encourage community action as well as individual action. For example, the community goal may be a predetermined energy consumption and/or carbon emission threshold. The community goal may also be a percentile reduction of the total and/or average community consumption. As occupants of dwellings associated with the community fulfill the community goal by implementing the recommendations as described above, the community goal may be adjusted to a new predetermined value to encourage further actions.

It is contemplated that inter-community comparison as well as intra-community comparison may be implemented by the present embodiments to encourage community action and/or individual action. In one embodiment, a member of a community may compare his utility consumption against the utility consumption of one or more members of the same community. Furthermore, the utility consumption of one or more members may be compared against one or more predetermined utility consumption benchmarks or a community utility consumption average. Similarly, amount of implementation of various recommendations and/or number of goals completed by a member may be compared against one or more members of the same community. It is further contemplated that the utility consumption of a community, amount of implementation of various recommendations and/or number of goals achieved by a community may be compared against that of another community. In one embodiment, the inter-community comparison or intra-community comparison may be achieved by presenting in a user-interface a graphical representation of a user or a community's utility consumption next to another graphic representation of utility consumption. In this embodiment, the user receives substantially instant feedback on how the user or user's community's utility consumption compared against another user or community's utility consumption.

Furthermore, the present computer-implemented devices, systems, and methods contemplate utilizing games such as videogames, merit badges, sweepstakes, etc. to encourage implementation of the recommendations. For example, the present embodiments may present a computer-aided interface to an occupant of a dwelling comprising utility consumption for that dwelling as well as utility consumption for one or more other dwellings in the community. The computer-aided interface may present graphical and/or textual information to foster energy reduction competitions among the different dwellings by encouraging social comparison, competition, and/or conformity. For example, occupants of dwelling A may be motivated by the game to reduce more carbon emission than occupants of dwelling B located across the street from dwelling A, and vice versa.

Furthermore, the present computer-implemented devices, systems, and methods contemplate utilizing group buy to incentivize or activate implementation of the recommendations. In general, group buy comprises offering to a group of potential purchaser a potential offer, the potential offer may reflect a discount for one or more items of services, the potential offer may be realized upon a sufficient number of purchasers accepting the offer. Specifically, it is contemplated that various data including demographic data, psychographic profiles, dwelling profiles, community profiles, utility consumption profiles, savings profiles as described above may be used to target an individual or a group such as a user-created community to purchase or implement one or more recommendations by directing targeted offers related to the implementation of the recommendations. For example, if one or more savings profiles reveal that installing a solar panel is a feasible implementation and one or more dwelling profiles reveal that a group of occupants is receptive to dwelling modifications, then a group buy offer for a solar panel may be presented to the group of occupants. Similarly, the various data may be used to incentivize or activate a vendor, manufacturer, and/or service provider to offer group buy discount campaigns.

It is noted that the various embodiments of the disclosed computer-implemented devices, systems, and methods may be implemented as an application such as a web widget that that can be installed and executed within a webpage, a TV set widget, or a desktop widget. The application may be implemented using JavaScript, Flash, HTML and CSS. The application may utilize various web technologies such as browser APIs or web application engine such as Akamai, Clearspring, KickApps, or the like. The application may be embedded in a third-party webpage, or it may be a desktop application configured to operate within various operating systems. For example, a savings calculation application that is configured to allow a user to compute potential savings related to implementing a recommendation may be embedded in a third party webpage, for example, a user's facebook page. Upon user interaction, the savings calculation application may interact with the savings generator 250 as described above to present potential savings to the user.

It is noted that the disclosed methods and systems as described above and illustrated in the corresponding flow diagram can be implemented by computer program instructions. These program instructions may be provided to a processor to produce a machine, such that the instructions may create means for implementing the various steps specified above and in the flow diagrams.

The computer program instructions may be executed by a processor to cause a series of steps as described to be performed by the processor to produce a computer implemented process such that the instructions, which execute on the processor to provide steps for implementing the steps as described. The computer programs instructions may also cause at least some of the steps to be performed in parallel. It is envisioned that some of the steps may also be performed across more than one processor, for example, in a multi-processor computer system. In addition, one or more steps or combination of steps may also be performed concurrently with other steps or combinations of steps, or even in a different sequence than described.

It is further noted that the steps or combination thereof as described above may be implemented by special purpose hardware-based systems configured to perform the specific steps of the disclosed methods, or various combinations of special purpose hardware and computer instructions.

While the above is a complete description of the preferred embodiments of the invention, various alternatives, modifications, and equivalents may be used. Therefore, the above description should not be taken as limiting the scope of the invention, which is defined by the appended claims.

What is claimed is:

1. A computer-implemented method for making utility savings recommendations, comprising:
generating a historical utility consumption profile for a dwelling over a period of time and itemized according to dwelling attributes, wherein the profile is generated by computing a seasonal portion and a non-seasonal portion of total utility consumption, wherein the non-seasonal portion is based on an average utility consumption of one or more predetermined intervals within the time period, and the seasonal portion is a difference between the total consumption and the non-seasonal consumption;
generating a list of recommendations to improve utility consumption efficiency of the dwelling;
estimating a reduction in utility consumption for each recommendation, based on the itemized consumption profile; and
generating a savings profile indicating the recommendations and their corresponding reduction estimates.

2. The method of claim 1, further comprising presenting the estimates as a percentage of total historical utility consumption to a user.

3. The method of claim 1, wherein the itemized utility consumption profile is an itemized natural gas consumption profile, and the seasonal consumption is natural gas consumption attributable to seasonal heating.

4. The method of claim 1, wherein the itemized utility consumption profile is an itemized electricity consumption profile, and the seasonal consumption is electricity consumption attributable to seasonal cooling.

5. The method of claim 1, wherein the itemized utility consumption profile is an itemized water consumption profile, and the seasonal consumption is water consumption attributable to outdoor water consumption.

6. The method of claim 1, further comprising ranking the recommendations in the savings profile according to their corresponding reduction estimates and presenting the ranked recommendations to a user.

7. The method of claim 1, further comprising estimating monetary savings corresponding to the reduction estimates.

8. The method of claim 7, further comprising ranking the recommendations in the savings profile according to the estimated monetary savings and presenting the ranked recommendations to a user.

9. The method of claim 1, further comprising estimating carbon savings corresponding to the reduction estimates.

10. The method of claim 9, further comprising ranking the recommendations in the savings profile according to the estimated carbon savings and presenting the ranked recommendations to a user.

11. The method of claim 1, further comprising ranking the recommendations in the savings profile according to modification cost and presenting the ranked recommendations to a user or ease of implementation and presenting the ranked recommendations to a user.

12. The method of claim 1, further comprising ranking the recommendations in the savings profile based on one or more preferences of the occupants and presenting the ranked recommendations to a user.

13. The method of claim 1, further comprising ranking the recommendations in the savings profile such that when a first recommendation builds upon a second recommendation, then the first recommendation is ranked lower than the second recommendation and presenting the ranked recommendations to a user.

14. The method of claim 1, further comprising grouping the recommendations according to one or more characteristics of the recommendations into one or more bundles and presenting a bundle to a user.

15. The method of claim 15, further comprising presenting an estimated reduction in utility consumption for the bundles.

16. The method of claim 1, further comprising ranking the recommendations in the savings profile based on likelihood of action by the occupants, wherein likelihood of action is based on one or more psychographic profiles of the occupants or a geographic region associated with the dwelling.

17. The method of claim 1, further comprising ranking the recommendations according to a user preference and presenting the ranked recommendations and the reduction estimates to a user.

18. The method of claim 1, further comprising generating and presenting an estimated future consumption data to a user.

19. The method of claim 1, further comprising:
obtaining historical utility consumption of one or more similar dwellings in a geographical region where dwelling is located; and
presenting a comparison of the historical utility consumption of the dwelling and the historical utility consumption of the similar dwellings in the geographical region.

20. The method of claim 1, further comprising:
obtaining historical utility consumption of another dwelling in the geographical region of the dwelling; and
presenting a utility consumption goal based on the utility consumption of another dwelling.
